(19) United States
(12) Patent Application Publication
(10) Pub. No.: US 2005/0034982 A1
(43) Pub. Date: Feb. 17, 2005

(54) Sensor holder

(76) Inventors: Lars von Goes, Taby (SE); Mikael Nilsson, Bromma (SE); Tryggve Hemmingsson, Sollentuna (SE)

Correspondence Address: MORRISON & FOERSTER LLP, 425 MARKET STREET, SAN FRANCISCO, CA, 94105-2482, US

(21) Appl. No.: 10/664,494

(22) Filed: Sep. 16, 2003

(30) Foreign Application Priority Data
Sep. 16, 2002 (SE) SE 0202740-7
Oct. 2, 2002 (SE) SE 0202904-9

(51) Int. Cl. G01N 27/26

(52) U.S. Cl. 204/400; 204/424

(57) ABSTRACT

A sensor holder for a sensor detecting a component in a gas flow, said holder comprises a recess for a sensor and a body, said body being provided with channels for said gas flow so that the flowing gas is stabilised with regard to its temperature by said body, the resulting temperature of the gas being the same as that of said body and said sensor before reaching the sensor.

The present invention relates to a sensor holder for a sensor for detecting a component in a gas flow.

The sensor holder is intended to be mounted in any device for sensing a component in a gas, i.e. fractions and/or contents in a test gas. For example, exhalation air may be sensed for the content of, for example, nitric oxide, oxygen or carbon dioxide.

### TECHNICAL BACKGROUND

U.S. Pat. No. 5,788,832 describes a temperature compensated electrochemical gas sensor having a thermistor arranged within the sensor in a temperature insulative fashion. The object of U.S. Pat. No. 5,788,832 is to measure the temperature of the sensor, since the temperature of the gas to be sensed will vary. In order not to immediately convey the temperature of the gas to the thermistor, the thermistor is embedded in the sensor.

A problem with this device is that it is still not sure which temperature is measured. The most important temperature to know is the temperature of the sensor surface onto which the gas flows and this will still vary with the temperatures of the gas.

### SUMMARY OF THE INVENTION

The object of the present invention is to provide a device where the sensor surface keeps the same temperature during each measurement.

This is achieved with a sensor holder according to claim 1. The solution to the problem is to make sure that the sensor and the gas, which meets the sensor, have the same temperature. This can be obtained by providing a body in the sensor holder, which is provided with channels for the gas to be sensed to flow in so that both the gas and the sensor will obtain the same temperature as the body. I.e. no temperature gradient will be present between the gas to be sensed and the sensor surface. This has also the advantage that no condensate will form on the sensor, provided that the temperature is chosen above the dew point for the analysed gas.

Preferred embodiments of the present invention are disclosed in the following dependent claims.

### SHORT DESCRIPTION OF THE DRAWINGS

The present invention will now be described in more detail referring to the drawing, in which:

FIG. 1 illustrates a sensor holder according to the present invention in an exploded view from a first end, the sensor being excluded.

FIG. 2 illustrates the sensor holder in FIG. 1 in an exploded view from a second end.

FIG. 3 illustrates a side view in cross section of the sensor holder in FIG. 1.

FIG. 4 illustrates the sensor holder in FIG. 1 from the first end.

FIG. 5 illustrates a sensor in a perspective view from a first end.

FIG. 6 illustrates the sensor in a perspective view from a second end.

FIG. 7 illustrates the sensor in a plan view from the second end.

FIG. 8 illustrates a body for receiving the sensor according to a second embodiment of the present invention.

FIG. 9 illustrates a plan view from a closed end of the body in FIG. 8.

FIG. 10 illustrates a side view in cross section of the body in FIG. 8.

FIG. 11 illustrates a plan view from an open end of the body in FIG. 8.

FIG. 12 illustrates a body for receiving the sensor according to a third embodiment of the present invention.

FIG. 13 illustrates a side view in cross section of the body in FIG. 12.

FIG. 14 illustrates a plan view from an open end of the body in FIG. 12.

FIG. 15 illustrates a body for receiving the sensor according to a fourth embodiment of the present invention.

FIG. 16 illustrates a plan view from a closed end of the body in FIG. 15.

FIG. 17 illustrates a side view in cross section of the body in FIG. 15.

FIG. 18 illustrates a plan view from an open end of the body in FIG. 15.

FIG. 19 illustrates an embodiment where the sensor encloses the body.

FIG. 20 illustrates the embodiment in FIG. 19 in an exploded view.

FIG. 21 illustrates the embodiment in FIG. 19 in a sectional view.

### DETAILED DESCRIPTION OF PREFERRED EMBODIMENTS

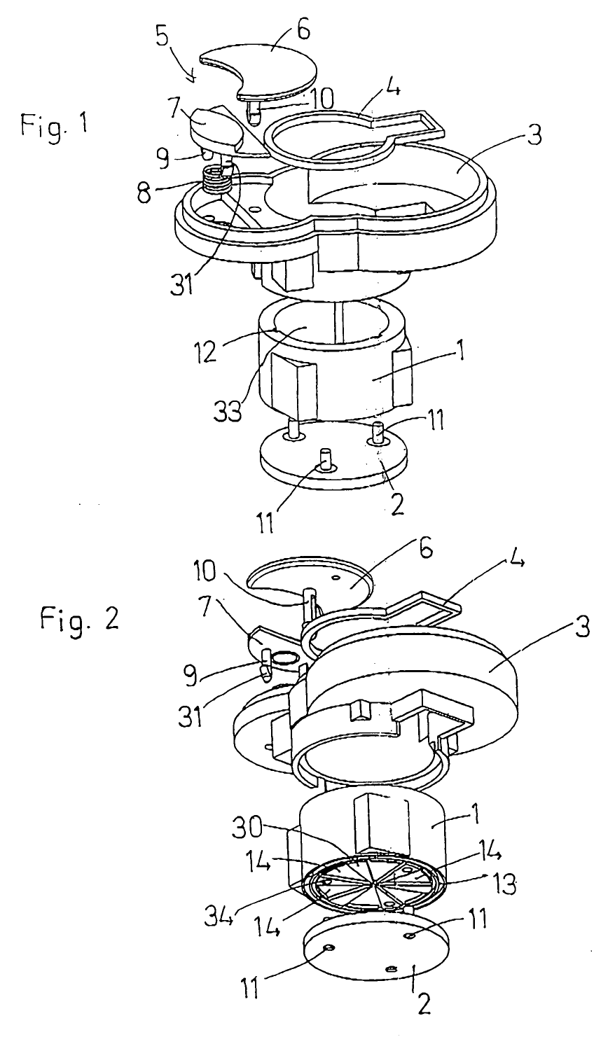

In FIGS. 1-4 a sensor holder according an embodiment of the present invention is illustrated. No sensor is present in the figure. The sensor holder comprises a body 1 provided in the shown embodiment with an integral inner end plate 30, which of course could be a separate end plate attached to the body 1. A second outer end plate 2 is attached to the inner end plate 30 for example by means of attachment means 11, such as screws, in for example attachment recesses 34 in the inner end plate 30. The main portion 1 of the body is preferably mainly cylindrical.

The body 1 is mounted to an opening portion 3 of the sensor holder. The opening portion 3 and the body 1 forms a recess for receiving a sensor 18 for detecting a component of a gas, which sensor may be inserted in the recess and is removably secured in the sensor holder by means of locking means 5.

The locking means 5 may be designed to comprise a depressable releaser 7 which is spring biased by a spring 8 to an outer position. In this embodiment two guide pins 9 run in two holes in the opening portion 3 in the direction of the spring 8. The guide pins 9 are provided with a stop 31 in each outer end so that the spring 8 may only force the depressable releaser 7 to the point where the stops meet the surface of the opening portion 3, i.e. its outer position.

The locking means further comprises a rotatable locking lid 6. It is provided with an axis 10 and is mounted in a hole in the opening portion 3. The axis 10 is provided with a stop 31, too, so that the locking lid 6 will not fall off. The locking lid 6 is only rotatable when the depressable releaser 7 is depressed from its outer position.

When the releaser 7 is in its outer position at least one lip or the like thereon stops the locking lid 6 from rotating from a locking position of the locking lid 6. When the locking lid 6 is in its locking position it covers at least a portion of the sensor 18 when the sensor 18 is received in the recess. The opening portion 3 is provided with space 17 for fingers so that it will be easy to insert and remove a sensor 18.

The body 1 is provided with different channels and ducts for conveying the gas to be sensed by the sensor 18. This can be done in various ways and an example will now be described. In the following, three further embodiments of a body will be described which may be comprised in a sensor holder according to the present invention.

The gas is conveyed in the channels in the body 1 in order to stabilise the temperature of the gas to the same temperature as that of the body 1 and also as that of the sensor, when present in the body 1. The larger contact surface of the body the gas is exposed to the quicker and more efficient the temperature stabilisation of the gas will be.

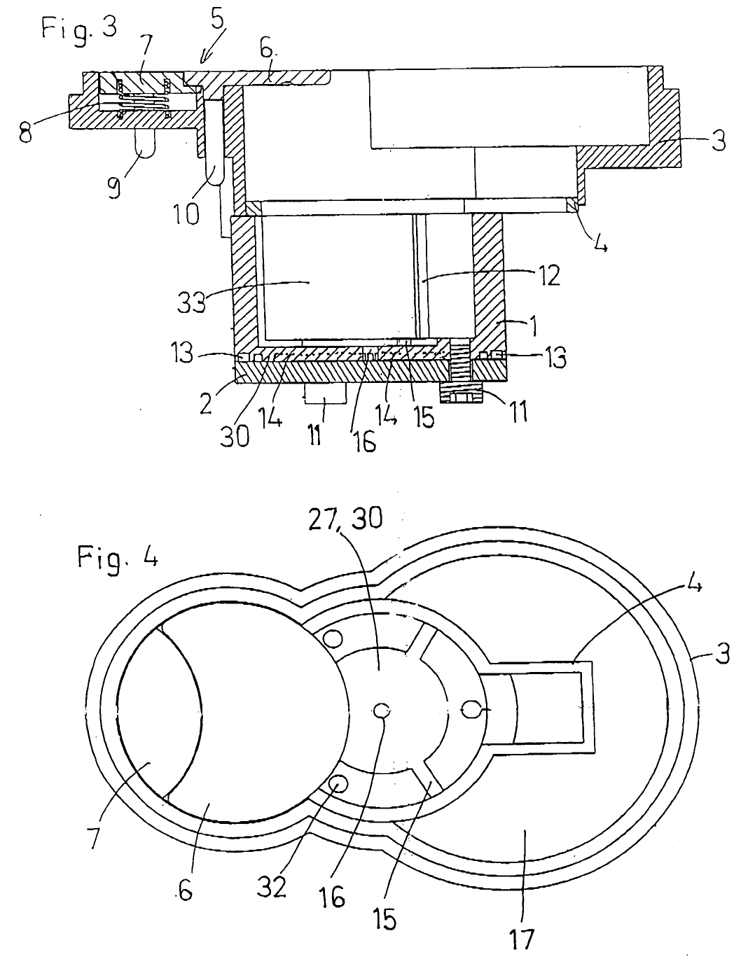

Between the inner 30 and the outer 2 end plates channels are provided. In the embodiment of FIGS. 1-4 the outer end plate is flat and the outer side 26 of the inner end plate 30 is provided with at least one gas inlet channel 13 around the periphery of the body, see FIGS. 2 and 3. The gas inlet channel 13 is for spreading inflowing gas around the periphery, the gas coming from a gas inlet duct in the outer end plate 2 (not shown).

Recesses 14 formed as circular segments are provided in the outer side 26 of the inner end plate 30 which together with the outer end plate 2 form channels leading from the periphery into a gas inlet hole 16 that conducts the flowing gas into the inner space 33 of the body where the sensor 18 is positioned in its use mode. The gas inlet hole 16 may be seen from the inner space 33 of the body 1 in FIG. 4.

Gas outlet channels 15 convey the gas that has reached the sensor 18 out from the centre of the inner side 30 of the inner end plate and towards the periphery to gas outlet ducts 12 along the sides of the main portion 1 of the body and out of the sensor holder.

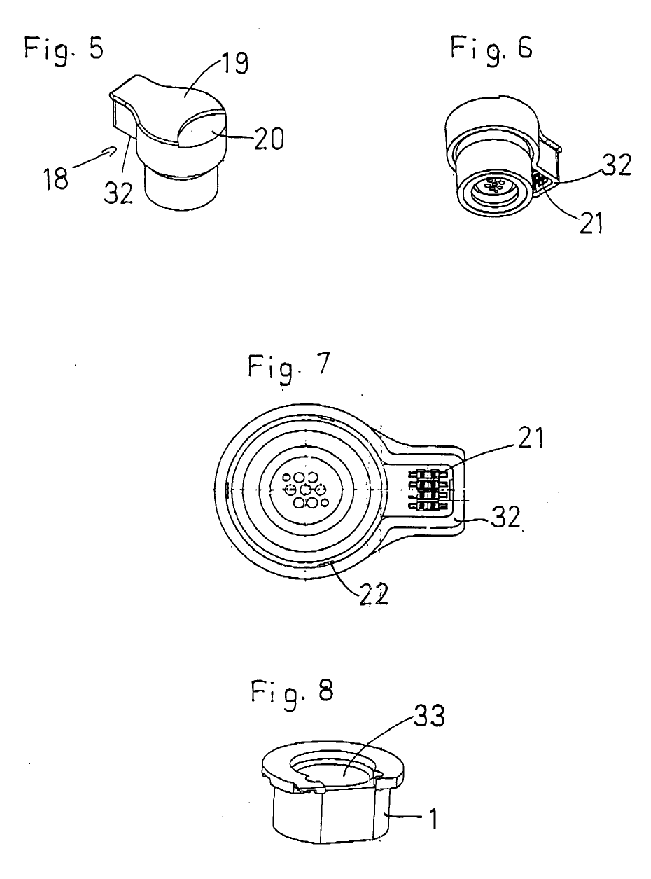

The sensor 18 is illustrated in FIGS. 5-7. The sensor comprises a lid 19 with a side flange having a rim 32. On the outside of the lid 19 a recess 20 is provided for the locking lid 6 of the sensor holder when the sensor 18 is positioned in the sensor holder and locked into place. The sensor comprises contact means 21.

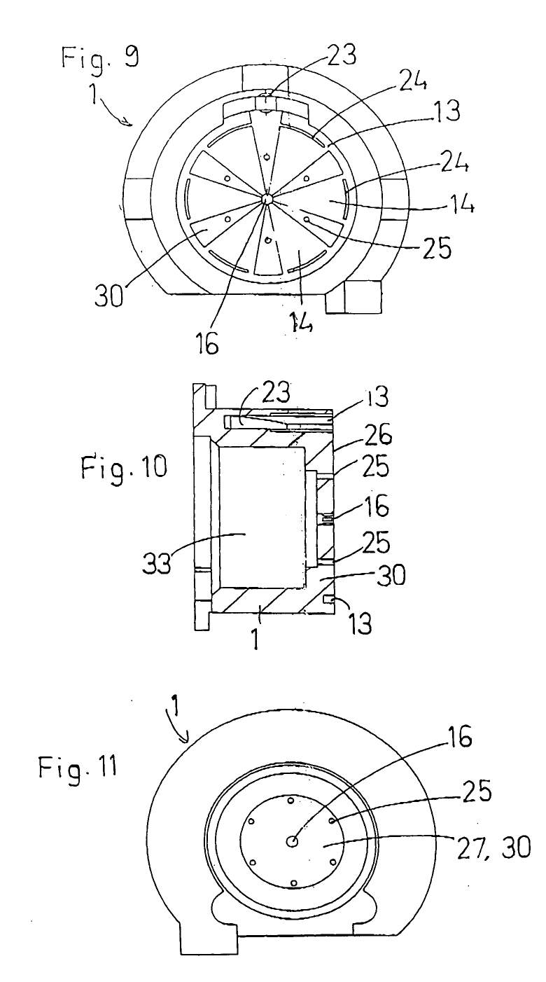

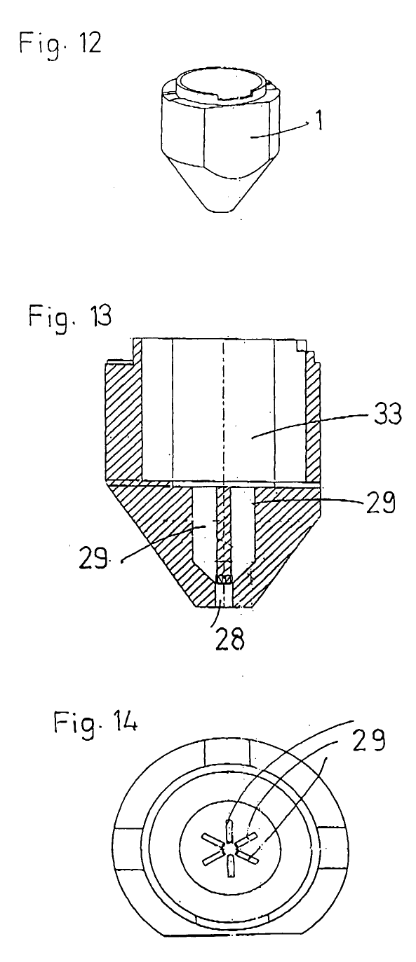

In FIGS. 8-11 a second embodiment of the body 1 of the present invention is illustrated. Also this embodiment is shown with an integral inner end plate 30 but it is conceivable to have a separate inner end plate, too. The gas enters through a hole in an outer end plate (not shown) and into a gas inlet duct 23.

From there it is spread around the periphery in a gas inlet channel 13 and further into recesses 14 formed as circular segments. In order to achieve an even spreading of the gas baffles 24 are provided to stop the gas to directly enter mainly in the two recesses 14 closest to the inlet duct 23.

The gas reaches the inlet hole 16 and is conveyed into the inner space 33 of the body 1, meets the sensor surface and is then conveyed out of the inner space 33 through gas outlet holes 25 and further out through the outer end plate 2 (not shown).

In FIGS. 12-14 a third embodiment of the body 1 of the present invention is illustrated. This body 1 differs from the two earlier embodiments in that it does not comprise two end plates. Instead the gas is led into a gas inlet duct 28 which is divided into for example six thin but wide gas inlet channels 29 so that the gas is exposed to a large contact surface of the body 1 in order to stabilise the temperature of the gas to the temperature of the body 1. The gas is evenly spread out onto the sensor surface in the inner space 33 of the body 1.

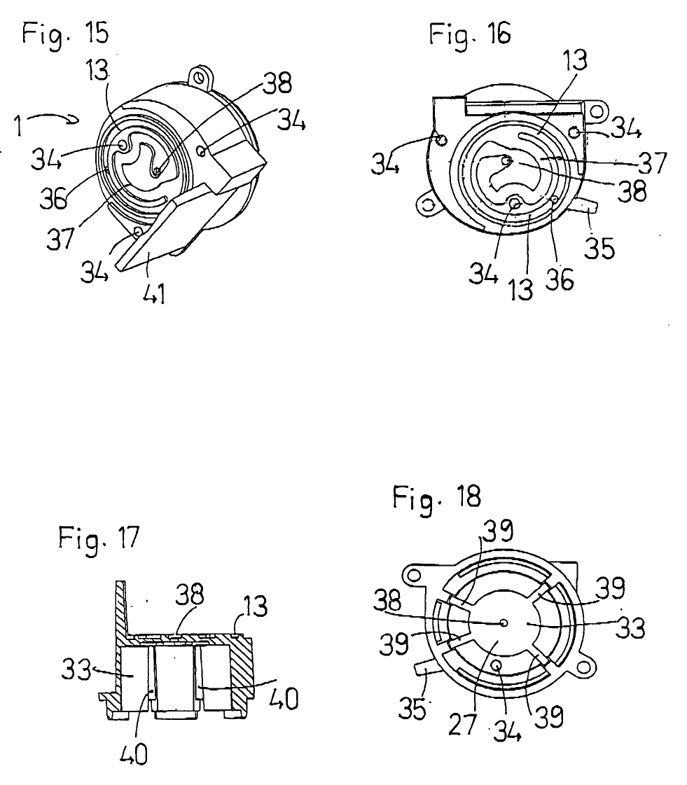

In FIGS. 15-18 a fourth embodiment of the body 1 of the present invention is illustrated. Also this embodiment is shown with an integral inner end plate 30 but it is conceivable to have a separate inner end plate, too. The gas enters through a gas inlet duct 35 and is lead through a hole 36 into a gas inlet channel 13.

The gas is spread around the periphery of the body 1 along the inlet channel 13 from the hole 36 in both directions. Roughly on the opposite side from the hole 36 the gas flow meets again and the gas will further flow via an inner channel 37 roughly formed as a coil towards an inlet hole 38 leading into the inner space 33 of the body 1. The gas flows onto the sensor 18 and further out through outlet channels 39 arranged at the inner side 27 of the inner end plate 30 and out via outlet ducts 40 along the wall of the body 1.

An outer end plate (not shown) is mountable to the inner end plate 30 by means of for example screws fitting a number of attachment recesses 34 (three in the shown embodiment). In this embodiment a wall 41 protrudes from the closed side of the body 1. At this wall cooling and/or heating means, such as a Peltier element (not shown), may be attached for cooling/heating the body.

Preferably the sensor 18 is electrically shielded by means of a conductive cage comprising the body 1 and the lid 19 of the sensor. Of course a separate lid could be provided in the sensor holder instead or as an additional lid (not shown). A gasket 4 may be provided between the opening portion 3 and the rim 32 of the sensor 18, see FIG. 3 in combination with FIG. 6. Preferably the gasket 4 is electrically conductive.

In order to achieve an even temperature in the body and sensor and to be able to stabilise the temperature of the flowing gas at least the body 1 in the sensor holder is made of a material with a high thermal conductivity, which makes sure that the temperature gradient is minimal. For example a composite material with a high thermal and electrical conductivity or a metal. Preferably other parts of the sensor holder, such as the outer end plate 2 and the opening portion 3, and the lid 19 of the sensor 18 are made of such a composite material or metal, too.

A temperature sensor may be positioned in the body (not shown). If desired cooling means, such as a peltier element, and/or heating means may be provided in the body 1 in order to be able to regulate the temperature interval for the body 1, sensor 18 and the gas that gives reliable results. In such case it is also possible to control the temperature in the body 1, sensor 18 and gas if control means are provided (not shown).

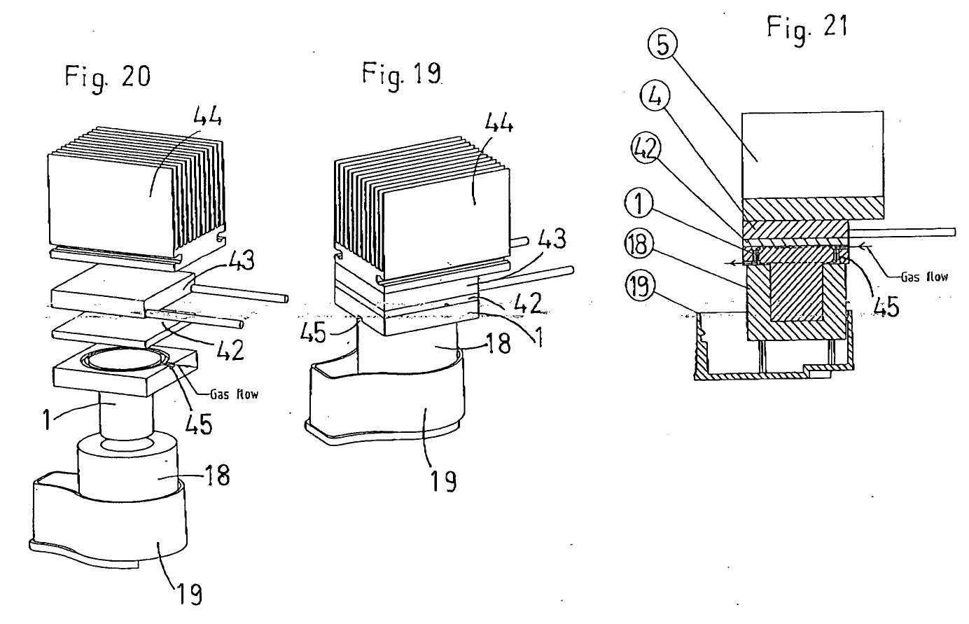

In another embodiment, see FIGS. 19, 20 and 21 the sensor 18 itself at least partially encloses the body 1. The sensor 18 will function as an insulator for the body 1. On the side not facing the sensor 18 the body 1 is provided with a lid 42 and preferably on the opposite side of the lid 42 there is a Peltier element 43 arranged. Cooling flanges 44 may be provided, too. Gas to be measured is let into the body 1 via a channel 45 and passes the sensor surface of the sensor 18. The body 1 is kept at a predetermined temperature, whereby the sensor surface and gas flowing through the body 1 also will maintain the same temperature as the body 1.

The present invention is not limited to the shown and described embodiments but can be varied and amended within the scope of the attached claims.

1. A sensor holder for a sensor detecting a component in a gas flow, characterised in that the holder comprises a recess for a sensor and a body, the body being provided with channels for the gas flow so that the flowing gas is stabilised with regard to its temperature by the body, the resulting temperature of the gas being the same as that of the body and the sensor before reaching the sensor.

2. A sensor holder according to claim 1, wherein the body at least partially encloses the sensor.

3. A sensor holder according to claim 1, wherein the body is made of metal or a composite material showing thermal and electrical conductivity.

4. A sensor holder according to claim 1, wherein the body is hollow and comprises gas channels between two end plates in one end of the body and at least one inlet hole in the inner end plate for the gas leading into the inner space of the body where the sensor is positioned in the use mode.

5. A sensor holder according to claim 4, wherein the body is mainly cylindrical.

6. A sensor holder according to claim 5, wherein the channels between the end plates are formed so that the incoming gas is spread around the periphery and then into the centre via channels having the form of segments of a circle, where the inlet hole is positioned.

7. A sensor holder according to claim 5, wherein the channels between the end plates are formed so that the incoming gas is spread around the periphery and then into the inlet hole in the vicinity of the centre via channels having the form of a coil, a maze or the like.

8. A sensor holder according to claim 1, wherein a temperature sensor is arranged in the body.

9. A sensor holder according to claim 1, wherein the sensor is electrically shielded by the body and a lid, both being electrically conductive.

10. A sensor holder according to claim 9, wherein an electrically conductive gasket is provided between the body and the lid in its closed position.

11. A sensor holder according to claim 1, wherein the sensor is locked into position in its use mode by locking means.
